(19) United States
(12) Patent Application Publication
(10) Pub. No.: US 2026/0075158 A1
(43) Pub. Date: Mar. 12, 2026

(54) NATURAL LANGUAGE VIDEO ANALYTICS SYSTEM AND A METHOD OF PROCESSING ONE OR MORE NATURAL LANGUAGE VIDEO ANALYTICS COMMANDS

(71) Applicant: Hendricks Corp. Pte. Ltd., Singapore (SG)

(72) Inventors: Yilin Jia, Singapore (SG); Ricky Sanjaya, Singapore (SG); Souhail Meftah, Singapore (SG); Kin Sun Wong, Singapore (SG); Wen Jin Zhu, Singapore (SG)

(73) Assignee: Hendricks Corp. Pte. Ltd., Singapore (SG)

(21) Appl. No.: 18/923,256

(22) Filed: Oct. 22, 2024

(30) Foreign Application Priority Data
Sep. 11, 2024 (AU) 2024219628

(51) Int. Cl. H04N 5/265

(52) U.S. Cl. CPC H04N 5/265

(57) ABSTRACT

An aspect of the present disclosure provides a natural language video analytics system. The system includes at least one processor and at least one memory including computer program code. The at least one processor, at least one memory and the computer program code are configured to allow the system to receive one or more natural language video analytics commands associated with video data, determine a validity of the one or more natural language commands using a trained neural network, in response to a positive determination of the validity of the one or more natural language commands, generate machine-readable video analytics instructions based on the one or more natural language commands using the trained neural network, and transmit the machine-readable video analytics instructions to a display module, the display module configured to update an output display based on the machine-readable video analytics instructions.

### TECHNICAL FIELD

The present invention generally relates to a natural language video analytics system and a method of processing one or more natural language video analytics commands.

### BACKGROUND ART

Video analytics systems are widely used in various applications, such as retail analytics, traffic management, security and surveillance. These systems use algorithms to process video data, extract insights and information. For example, in security applications, video analytics can detect suspicious behaviour, identify individuals, and alert personnel to potential threats. In retail environments, video analytics can help retailers understand customer behaviour, optimise store layouts, and improve sales strategies. Traffic management applications can benefit from real-time analysis of vehicular flow, congestion detection, and incident management.

Traditionally, users operate video analytics systems via graphical user interfaces (GUIs) or command-line controls. These conventional methods can be complex and inefficient, particularly for users lacking technical expertise. The methods often require extensive training and familiarity with the software, resulting in operational delays and an increased likelihood of errors. Moreover, reliance on manual interaction restricts the scalability and responsiveness of these systems, especially in environments demanding real-time analysis and swift decision-making.

Accordingly, what is needed is a natural language video analytics system and a method of processing one or more natural language video analytics commands that seek to address some of the above problems. Furthermore, other desirable features and characteristics will become apparent from the subsequent detailed description and the appended claims, taken in conjunction with the accompanying drawings and this background of the disclosure.

### SUMMARY OF INVENTION

An aspect of the present disclosure provides a natural language video analytics system. The system includes at least one processor and at least one memory including computer program code. The at least one processor, at least one memory and the computer program code are configured to allow the system to receive one or more natural language video analytics commands associated with video data, determine a validity of the one or more natural language commands using a trained neural network, in response to a positive determination of the validity of the one or more natural language commands, generate machine-readable video analytics instructions based on the one or more natural language commands using the trained neural network, and transmit the machine-readable video analytics instructions to a display module, the display module configured to update an output display based on the machine-readable video analytics instructions.

To determine the validity of the one or more natural language commands, the system can be configured to determine a relevance of the one or more natural language video analytics commands to analytics of the video data using the trained neural network and optionally, determine if the one or more natural language video analytics commands fall within a processing capability of the natural language video analytics system using the trained neural network.

The machine-readable video analytics instructions can include video overlay instructions, and the system can be configured to receive the video data and the video overlay instructions, modify the video data based on the video overlay instructions, and transmit the video data modified based on the video overlay instructions to the output display.

The machine-readable video analytics instructions can include video transformation instructions, and the system can be configured to receive the video data and the video transformation instructions, modify the video data based on the video transformation instructions, and transmit the video data modified based on the video transformation instructions to the output display.

The system can be configured to compare the machine-readable video analytics instructions against an access control list, in response to a result of the comparison indicative of authorised access, retrieve video-derived data from one or more databases associated with the set of video data, based on the machine-readable video analytics instructions, generate one or more data representations using the retrieved data and the machine-readable video analytics instructions, and transmit the one or more data representations to the display module.

The system can be configured to generate a text response based on the retrieved data and the machine-readable video analytics instructions, and transmit the text response to the display module. The system can also be configured to generate the video-derived data based on a pre-determined set of video analytics instructions using the video data and a trained video analytics algorithm, and store the video-derived data and the video data in the one or more databases.

Another aspect of the present disclosure provides a method of processing one or more natural language video analytics commands. The method includes receiving, by a processing device, one or more natural language video analytics commands associated with video data, determining, using the processing device, a validity of the one or more natural language commands using a trained neural network, in response to a positive determination of the validity of the one or more natural language commands, generating, using the processing device, machine-readable video analytics instructions based on the one or more natural language commands using the trained neural network, and transmitting, using the processing device, the machine-readable video analytics instructions to a display module, the display module configured to update an output display based on the machine-readable video analytics instructions.

The step of determining the validity of the one or more natural language commands using the trained neural network can include one or more of the steps of determining, using the processing device, a relevance of the one or more natural language video analytics commands to analytics of the video data using the trained neural network, and determining, using the processing device, if the one or more natural language video analytics commands fall within a processing capability of natural language video analytics system using the trained neural network.

The machine-readable video analytics instructions can include video overlay instructions, and the method can include receiving, by the display module, the video data and the video overlay instructions, modifying, using the display module, the video data based on the video overlay instructions, and transmitting, using the display module, the video data modified based on the video overlay instructions to the output display.

The machine-readable video analytics instructions can include video transformation instructions, and the method can include receiving, by the display module, the video data and the video transformation instructions, modifying, using the display module, the video data based on the video transformation instructions, and transmitting, using the display module, the video data modified based on the video transformation instructions to the output display.

The method can further include the steps of comparing, using the processing device, the machine-readable video analytics instructions against an access control list, in response to a result of the comparison indicative of authorised access, retrieving, using the processing device, video-derived data from one or more databases associated with the video data, based on the machine-readable video analytics instructions; generating, using the processing device, one or more data representations using the retrieved data and the machine-readable video analytics instructions, and transmitting, using the processing device, the one or more data representations to the display module, the display module configured to update the output display based on the one or more data representations.

The method can also include the steps of generating, using the processing device, a text response based on the retrieved data and the machine-readable video analytics instructions, and transmitting, using the processing device, the text response to the display module. The method can further include the steps of generating, using the processing device, the video-derived data based on a pre-determined set of video analytics instructions using the video data and a trained video analytics algorithm, and storing the video-derived data and the video data in the one or more databases.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a schematic diagram of a natural language video analytics system, in accordance with embodiments of the disclosure.

FIG. 2 shows a schematic diagram of an example implementation of the natural language video analytics system of FIG. 1, in accordance with embodiments of the disclosure.

FIG. 3 shows a flowchart illustrating a method of processing one or more natural language video analytics commands, in accordance with embodiments of the disclosure.

FIG. 4 shows a schematic diagram of a computing device used to realise the system of FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

Embodiments of the present invention will be described, by way of example only, with reference to the drawings. Like reference numerals and characters in the drawings refer to like elements or equivalents. The following detailed description is merely exemplary in nature and is not intended to limit the invention or the application and uses of the invention. Furthermore, there is no intention to be bound by any theory presented in the preceding background of the invention or the following detailed description. Herein, a modular fluid processing tank is presented in accordance with present embodiments having the advantages of transportability, modularity and scalability.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “associating”, “calculating”, “comparing”, “determining”, “forwarding”, “generating”, “identifying”, “including”, “inserting”, “modifying”, “receiving”, “replacing”, “retrieving”, “scanning”, “storing”, “transmitting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

The term “configured to” is used in the specification in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Embodiments of the present disclosure provide a natural language video analytics system and a method of processing one or more natural language video analytics commands. The natural language video analytics system can include a trained neural network, hereinafter interchangeably referred to as a generative artificial intelligence (GenAI) or a large language model (LLM). In exemplary embodiments, the natural language video analytics system can receive one or more natural language video analytics commands associated with video data, generate machine-readable video analytics instructions based on the one or more natural language commands using the trained neural network and transmit the machine-readable video analytics instructions to a display module configured to update an output display based on the machine-readable video analytics instructions. In other words, the natural language video analytics system in accordance with embodiments of the invention can leverage on trained neural networks to enhance video analysis and video analytics capabilities, and can assist users in real-time decision making, surveillance and anomaly detection.

In embodiments of the present disclosure, the video analytics system can process and analyse video data to extract information. The system can use algorithms, including neural networks, to detect and interpret patterns, objects, and events within the video data. The system can be used in a variety of applications, including, but not limited to security surveillance, traffic monitoring and behavioural analysis. The video analytics system in accordance with embodiments of the disclosure can provide more effective and efficient decision-making and real-time alerts based on the analysed video data.

In exemplary embodiments, the natural language video analytics system can be configured to run computer program code, hereinafter interchangeably referred to as one or more applications including, but not limited to, a video analytics application, a data visualisation application and an image resolution enhancer application. In exemplary embodiments, the video analytics application can include computer-readable instructions which when executed by a processor of the natural language video analytics system, cause the processor to use the trained neural network to generate machine-readable instructions based on natural language instructions from a user, and to use the machine-readable instructions to dynamically adjust image processing parameters, enhance display settings, enable real-time analysis and manage the video footage on the output display.

In exemplary embodiments, the data visualisation application can include computer-readable instructions which when executed by the processor of the natural language video analytics system, cause the processor to use the trained neural network to generate machine-readable instructions based on natural language instructions from the user, and to generate data visualisation information based on the machine-readable instructions and update the output display using the data visualisation information. The data visualisation application can also cause the natural language video analytics system to generate instructions which can be used to dynamically resize and/or reorganise the data visualisations presented on the output display to facilitate user analysis.

Exemplary embodiments of the present disclosure can also include the image resolution enhancement application comprising computer-readable instructions which when executed by the processor of the natural language video analytics system, cause the processor to increase a resolution of an image beyond its original resolution by using a general adversarial network (GAN). A suitable general adversarial network (GAN) can include, but is not limited to, Real-ESRGAN (Real-World Enhanced Super-Resolution General Adversarial Network). The image resolution enhancement application can also cause the natural language video analytics system to estimate the number of individuals in a designated area of an image (i.e. to crowd count), and to perform crowd counting using HRNet (High-Resolution Net) to generate segmentation maps and FIDT (Focal Inverse Distance Transform) to localise crowds on the generated segmentation maps. In embodiments, an image can be an image frame within a sequence of image frames which when played in succession forms a video.

In exemplary embodiments, video data can include, but is not limited to, one or more of the following: live video stream data and recorded video data, the live video stream data being video content captured and transmitted in real-time, and the recorded video data being video content captured and stored for deferred playback or analysis. The video data can include a digital representation of content captured by one or more image capturing devices and can be stored in the form of sequences of images or image frames. Video data can also include metadata such as resolution, frame rate, encoding format, duration, and additional details like timestamps, camera settings, and geolocation data. In embodiments of the invention, video data can include video analytics data, the video analytics data being information derived from the analysis of video data using processes described hereinafter, and can include, but is not limited to patterns, trends, and metrics derived from the video data.

In exemplary embodiments, video analytics instructions can include, but is not limited to one or more of the following: video overlay instructions and video transformation instructions. Video overlay instructions can include machine-readable instructions that can cause the video analytics system to include additional visual elements, such as text, images, or graphics on a video displayed on an output display. The instructions can also include instructions associated with the position of the overlay elements relative to the video displayed on the output display, the interaction of the overlay elements with the underlying video content, and conditions for displaying or modifying the overlays. The elements can include, but not limited to, data representations associated with video analytics, bounding boxes, tracking identifiers, frames per second (FPS), and regions of interest (ROIs). Video transformation instructions can include machine-readable instructions that can cause the video analytics system to modify or manipulate video displayed on an output display. Video transformation instructions can include, but is not limited to, instructions for resizing, cropping, rotating, adjusting colour balance, applying filters or effects to the video displayed on an output display.

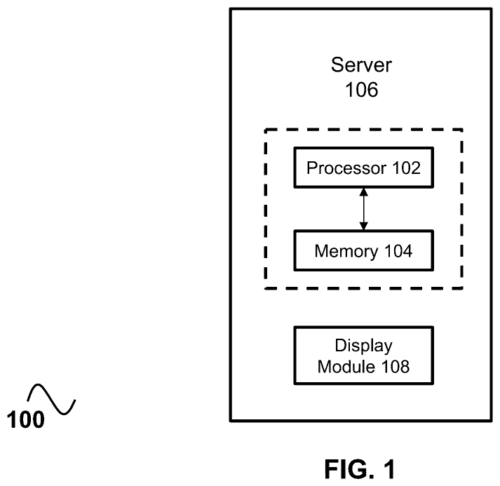

FIG. 1 shows a schematic diagram of a natural language video analytics system 100, in accordance with embodiments of the disclosure. In exemplary embodiments, the system 100 can include at least one processor 102 and at least one memory 104 including computer program code. The at least one processor 102 and the at least one memory 104 can be housed in a server 106. The server 106 can also include a display module 108 configured to update an output display. The at least one processor 102, at least one memory 104 and the computer program code are configured to allow the system 100 to receive one or more natural language video analytics commands associated with video data, determine a validity of the one or more natural language commands using a trained neural network, in response to a positive determination of the validity of the one or more natural language commands, generate machine-readable video analytics instructions based on the one or more natural language commands using the trained neural network and transmit the machine-readable video analytics instructions to the display module 108, the display module 108 configured to update the output display based on the machine-readable video analytics instructions.

In embodiments of the present disclosure, the display module 108 can be a separate server, or a component or subsystem within the server 106 that can render and present visual information to a user. The display module can include, but is not limited to, a graphics processing unit configured to render images, videos and other graphical data, an output display and associated circuitry configured to present visual information to the user. The display module is configured to facilitate interaction between the user and server associated with the display module by converting electronic signals into visual information.

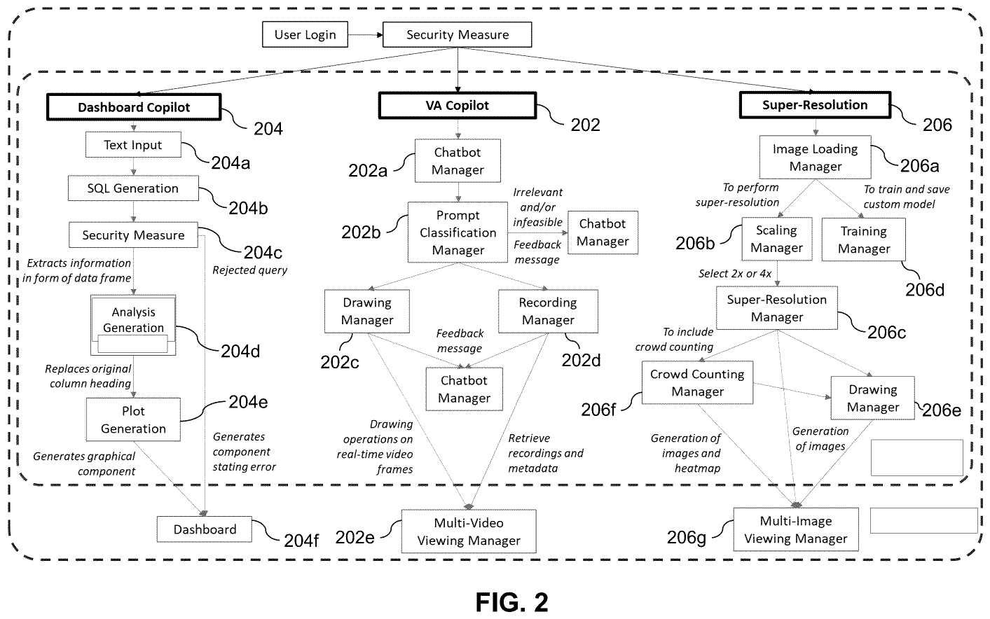

FIG. 2 shows a schematic diagram of an example implementation of the natural language video analytics system 100 of FIG. 1, in accordance with embodiments of the disclosure. The natural language video analytics system 100 can be configured to run a video analytics application 202, hereinafter interchangeably referred to as a video analytics (VA) copilot module associated with various video analytics functions. As will be described in detail below, the video analytics application 202 in accordance with embodiments of the invention can include a set of instructions in machine-readable format that is executable by the natural language video analytics system 100 to perform the various video analytics functions described herein. In example embodiments, the video analytics application 202 can cause the natural language video analytics system 100 to generate machine-readable video analytics instructions based on the one or more natural language commands from a user using the trained neural network. That is, the system 100 can generate video analytics instructions based on user commands in natural language, and these video analytics instructions can be associated with video playback changes that can dynamically adjust image processing parameters, enhance display settings, enable real-time analysis and manage the video footage.

The video analytics application 202 in accordance with embodiments of the disclosure can include one or more managers, each being a subroutine or program configured to perform one or more specific functions within the application. Each of the one or more managers can include instructions in machine-readable format that is executable by the natural language video analytics system 100 to perform the various functions described in more detail below. In an example embodiment, the video analytics application 202 can include, but is not limited to, a chatbot manager 202a, a prompt classification manager 202b, a drawing manager 202c, a recording manager 202d and a multi-video viewing manager 202e. In embodiments of the present disclosure, the video analytics application 202 can cause the natural language video analytics system 100 to receive one or more natural language video analytics commands associated with video data, determine a validity of the one or more natural language commands using a trained neural network, generate machine-readable video analytics instructions based on the one or more natural language commands using the trained neural network in response to a positive determination of the validity of the one or more natural language commands, and transmit the machine-readable video analytics instructions to a display module, the display module configured to update an output display based on the machine-readable video analytics instructions. In determining the validity of the one or more natural language commands, the video analytics application 202 can cause the natural language video analytics system 100 to determine a relevance of the one or more natural language video analytics commands to analytics of the video data using the trained neural network and optionally, determine if the one or more natural language video analytics commands fall within a processing capability of the natural language video analytics system using the trained neural network.

In embodiments of the present disclosure, the machine-readable video analytics instructions can include video overlay instructions, and the video analytics application 202 can cause the natural language video analytics system 100 to receive the video data and the video overlay instructions, modify the video data based on the video overlay instructions, and transmit the video data modified based on the video overlay instructions to the output display.

In example embodiments, the machine-readable video analytics instructions can include video transformation instructions, and the video analytics application 202 can cause the natural language video analytics system 100 to receive the video data and the video transformation instructions, modify the video data based on the video transformation instructions and transmit the video data modified based on the video transformation instructions to the output display.

The video analytics application 202 can also cause the natural language video analytics system 100 to compare the machine-readable video analytics instructions against an access control list, retrieve video-derived data from one or more databases associated with the set of video data, based on the machine-readable video analytics instructions in response to a result of the comparison indicative of authorised access, generate one or more data representations using the retrieved data and the machine-readable video analytics instructions and transmit the one or more data representations to the display module. The video analytics application 202 can also cause the natural language video analytics system 100 to generate the video-derived data based on a pre-determined set of video analytics instructions using the video data and a trained video analytics algorithm, and store the video-derived data and the video data in the one or more databases.

In embodiments of the present disclosure, the chatbot manager 202a can cause the video analytics system 100 to generate instructions associated with management of a graphical user interface (GUI) and facilitate user interaction between the user and the natural language video analytics system 100. For example, the chatbot manager 202a can cause the video analytics system 100 to receive one or more user commands, run prompt classification manager 202b for further processing of the one or more user commands, and display a response indicative of a result of the processing via the GUI. The chatbot manager 202a can also cause the video analytics system 100 to generate feedback messages using the drawing manager 202c and the recording manager 202d and display the feedback messages via the GUI. In embodiments of the present disclosure, the drawer manager 202c can cause the system 100 to perform drawing operations on the video frames while the recording manager 202d can cause the system 100 to retrieve recordings and metadata.

The prompt classification manager 202b can cause the video analytics system 100 to transmit and receive messages from a large language model (LLM), i.e. to maintain a LLM session. The prompt classification manager 202b can cause the video analytics system 100 to initiate the LLM session with a pre-written prompt containing guidelines for handling user requests, and use the LLM to perform one or more of the following (i) relevance assessment, (ii) feasibility analysis and (iii) requirements categorisation. In an example embodiment, the prompt classification manager 202b in relevance assessment can cause the video analytics system 100 to determine a relevance of the one or more natural language video analytics commands to analytics of the video data set using the trained neural network based on a user-defined screening prompt. In an embodiment, the user-defined screening prompt can include contextual information about video analytics, the contextual information including, but not limited to, relevant keywords, examples, and guidelines for the LLM to determine if the commands are related to video analytics. In an embodiment, any commands that is deemed to be outside the scope of video analytics is classified as “irrelevant”. The prompt classification manager 202b can cause the video analytics system 100 to transmit a message indicative of the determination result, and run the chatbot manager 202a, which can cause the system 100 to display a text explanation to the user via the GUI. If the user request is deemed to be relevant to video analytics, it is classified as “relevant”.

In feasibility analysis, the prompt classification manager 202b can cause the video analytics system 100 to determine, using the trained neural network, if the one or more natural language video analytics commands fall within a processing capability of the natural language video analytics system 100. In an example, the feasibility of a command can be determined based on the natural language video analytics system functionalities and the data type it can process, for example, in association with bounding boxes, tracking identifiers, and region of interests (ROIs). If the command is deemed to be infeasible, the prompt classification manager 202b can cause the video analytics system 100 to run the chatbot manager 202 to display a message indicative of the feasibility determination result to the user via the GUI. In an example embodiment, analysis of the feasibility of the natural language video analytics command can follow relevance assessment of the natural language video analytics command.

In requirements categorisation, the prompt classification manager 202b can cause the video analytics system 100 to categorise commands into one of the two categories of display or recording. The commands that require real-time video feed processing are classified in the “display” category and will be handled by the drawing manager 202c. Commands that relate to processed or stored video data are classified in the “recording” category and will be handled by the recording manager 202d.

In embodiments of the present disclosure, the video data can include, but is not limited to video stream data, and the machine-readable video analytics instructions generated based on the one or more natural language commands using the trained neural network can include video overlay instructions. In exemplary embodiments, the video overlay instructions can include machine-readable instructions for drawing on real-time video data using features including, but not limited to, bounding boxes, tracking identifiers, frames per second (FPS), and regions of interest (ROIs). The natural language video analytics system 100 can be configured to receive the video data and the video overlay instructions, modify the video data based on the video overlay instructions and transmit the modified video data to the output display. In an embodiment, the drawing manager 202c that can cause the video analytics system 100 to process aforementioned steps, and to generate the machine-readable video analytics instructions based on the one or more natural language commands using the trained neural network process. In example embodiments, the drawing manager 202c can cause the video analytics system 100 to process drawing operations on real-time video data using features like bounding boxes, tracking identifiers, frames per second (FPS), and regions of interest (ROIs). As will be explained in the paragraph below, the drawing manager 202c can cause the video analytics system 100 to be initialised with pre-defined configurations and can maintain a live display using the display module (e.g. show live video feeds and associated real-time video analytics information). The drawing manager 202c can also cause the video analytics system 100 to use threading to process on the one or more natural language commands using the trained neural network without disrupting the video processing loop.

In example embodiments, the drawing manager 202c can cause the natural language video analytics system 100 to execute a sequence of steps to overlay features such as bounding boxes, tracking identifiers, frames per second (FPS), and regions of interest (ROIs) on real-time video data shown on the output display. The steps include, but is not limited to (i) receiving a message including the one or more natural language commands, methods to update, background information, and task constraints, (ii) generating machine-readable video overlay instructions (e.g. python code) based on the one or more natural language commands using the trained neural network, (iii) executing the machine-readable video overlay instructions, (iii) modifying the video data based on the video overlay instructions and (iv) transmitting the modified video data to the output display. The drawing manager 202c can cause the video analytics system 100 to generate a feedback message associated with the above processing, and the feedback message can be access by the chatbot manager 202a via a shared memory segment on the natural language video analytics system 100.

In embodiments of the present disclosure, the “methods to update” include specific actions or techniques that dictate how the requested changes should be applied to the video. The methods include but is not limited to user requests to change display settings such as text and background colours, toggle visibility of elements, and adjust screen preferences. The “background information” includes contextual information provided by the user for the drawing manager to produce the desired output. For example, background information can include details about the video stream format, existing overlays, current playback speed, or specific areas of interest in the video. The contextual information can ensure that the generated instructions are appropriate and relevant to the current state of the video data. The “task constraints” includes limitations or requirements that the drawer manager must adhere to while processing the user's request. The limitations or requirements can include, but is not limited to, specific regions where overlays should not be applied or compatibility requirements with the existing video data format. These limitations or requirements can ensure that the generated code is feasible and aligned with the system's capabilities and requirements.

In embodiments of the present disclosure, the video data can include, but is not limited to, one or more recorded video stream data sets, and the machine-readable video analytics instructions generated based on the one or more natural language commands using the trained neural network can include video transformation instructions. The natural language video analytics system 100 can be configured to receive the video data and the video transformation instructions, modify the video data based on the video transformation instructions and transmit the modified video data to the output display. In an embodiment, the recording manager 202d can cause the video analytics system 100 to process aforementioned steps. The recording manager 202d can cause the video analytics system 100 to generate the machine-readable video transformation instructions based on the one or more natural language commands using the trained neural network process.

In embodiments, the recording manager 202d can cause the natural language video analytics system 100 to generate the video-derived data based on a pre-determined set of video analytics instructions using the video data and a trained video analytics algorithm and store the video-derived data and the video data in the one or more databases. The video-derived data can include video analytics data associated with the video data. In an example embodiment, the recording manager 202d can cause the natural language video analytics system 100 to retrieve video data and video-derived data stored on one or more databases based on the machine-readable video analytics instructions; generate one or more data representations using the retrieved data and the machine-readable video analytics instructions and transmit the one or more data representations to the display module. The one or more data representations can include, but is not limited to, additional video analytics data and statistical information associated with the video data, the video-derived data or both the video data and the video-derived data.

In an example embodiment, the recording manager 202d can cause the natural language video analytics system 100 to (i) receive a message including the one or more natural language commands, the background information, the methods to update, arguments (i.e. any additional inputs required by the LLM), required returns (i.e. required outputs e.g. return code or response from the LLM), and the task constraints (ii) spawn a new process to run the return code or response and (iii) share the feedback message with the Chatbot Manager via shared memory. In embodiments, the returned response can include a “processing_recording” method for later execution.

In example embodiments, the multi-video viewing manager 202e can cause the video analytics system 100 to display multiple videos side-by-side at once on an output display. The multiple videos can include, but is not limited to, an original video and video modified by the natural language video analytics system 100 based on the one or more natural language video analytics commands. The multi-video viewing manager 202e can also cause the video analytics system 100 to receive and process natural language video analytics commands associated with management of the video windows, the video windows being graphical user interface elements that display video content on the output display. Each window can show a separate video stream or file, and can be individually controlled, resized, and repositioned by the user.

In example embodiments, a security manager (not shown) can cause the natural language video analytics system 100 to execute instructions which can enhance security of the natural language video analytics system 100. In an example embodiment, access to the video analytics application 202 can require users to first complete a multi-factor authentication. Further, access levels can be based on user roles. For example, an operator of the natural language video analytics system 100 can access core functionalities such as managing live feeds, reviewing stored recordings, and performing system maintenance tasks, while having limited control over user management and system settings. A viewer or a guest may have restricted access to view live feeds only and cannot review stored recordings or make changes to the system. An administrator has full access to system features, settings, and data, and can manage users, permissions, and configurations of the natural language video analytics system 100.

The video analytics application 202 in accordance with embodiments of the present disclosure can address technical problems associated with secure execution of video analytics queries, generation of effective video analytics machine-readable instructions, and the generation of a user interface for navigation and analysis. Advantageously, the video analytics application 202 in accordance with embodiments of the present disclosure can (i) generate machine-readable data video analytics instructions based on the users' natural language commands, (ii) generate and implement video analytics data visualisation, i.e., generate a suitable data visualisation and implement necessary modifications to the video data to represent the video analytics data properly, (iii) generate an effective user interface, i.e., generate a visual information display where the users can interact with the displayed data and manipulate the dashboard components to their needs (e.g. a user interface that can facilitate ease of navigation of different components, i.e., chat assistant, video window, buttons for record, play, pause, and save, history log etc. and facilitates analysis, i.e., having multi-video window for comparison, ability to rearrange widgets, analytics summary console, alerts, etc.) and (iv) enhance security measures to prevent malicious attacks, i.e., implement security measures to mitigate unauthorised access to video data.

Embodiments of the present disclosure also provide a data visualisation application 204, hereinafter interchangeably referred to as a dashboard copilot module. The data visualisation application 204 can cause the video analytics system 100 to use the trained neural network to generate machine-readable instructions based on natural language instructions from the user, generate data visualisation information based on the machine-readable instructions and update the output display using the data visualisation information. The data visualisation application 204 can cause the video analytics system 100 to generate instructions which can dynamically resize and/or reorganise the data visualisations presented on the output display to facilitate user analysis.

In exemplary embodiments, the data visualisation application 204 can include a text input module 204a which can cause the video analytics system 100 to receive one or more natural language video analytics commands associated with video data. The one or more natural language video analytics commands can include, but is not limited to, information to be extracted from the video data and optionally, the method or format used to represent data graphically (e.g. bar charts, line graphs etc.). The data visualisation application 204 can also include a database management command (e.g. Structured Query Language (SQL) command) generation component 204b which can cause the video analytics system 100 to determine a validity of the one or more natural language commands using a trained neural network, and generate machine-readable video analytics instructions based on the one or more natural language commands using the trained neural network in response to a positive determination of the validity of the one or more natural language commands. In an example embodiment, the data visualisation application 204 can cause the video analytics system 100 to generate a prompt for an LLM based on the one or more natural language video analytics commands, and generate a SQL query using the LLM based on the prompt, the prompt including information about the database associated with the video-derived data and video data, examples of queries and responses, and additional instructions which can include renaming of column headings from a result table associated with a response to the SQL query. The generated SQL query can be used to extract information from the database, where the results are stored in tabular form containing the values and renamed column headings.

In exemplary embodiments, the data visualisation application 204 can include a security component 204c. The security component 204c can cause the video analytics system 100 to execute a sequence of steps to determine the relevance of the output from the text input module 204a, compare the machine-readable video analytics instructions against an access control list and permit further processing of the machine-readable video analytics instructions in response to a result of the comparison indicative of authorised access. In an example embodiment, the security component 204c can cause the video analytics system 100 to receive a credential for verification and authentication from a user before providing the user access to the data visualisation application 204. The credential can also determine the database privileges and permissions that the user has. In an embodiment, the generated SQL query can be passed through one or more of a blacklist and a whitelist check to mitigate SQL injection attacks. The blacklist can be used to reject SQL queries that include prohibited commands or keywords. The whitelist can be used to reject SQL queries that do not include certain commands or keywords. In an embodiment, only queries that have not been rejected by these two lists will be used to extract information from the database.

In exemplary embodiments, the data visualisation application 204 can include an analysis generation module 204d. The analysis generation module 204d can cause the video analytics system 100 to execute a sequence of steps to generate a text response to the natural language command based on the data extracted using SQL query generated by component 204b with the prompt. The prompt can include the extracted data using the SQL query generated by component 204b and additional instructions.

The data visualisation application 204 can also include a plot generation module 204e. The plot generation module 204e can cause the video analytics system 100 to generate one or more data representations, also referred hereinafter as data visualisation using the result table with renamed column headings with a prompt using the LLM with a prompt. The prompt can include the result table with the renamed column headings, examples of plot type to be used depending on the query, and additional instructions. The result is Python code that will be executed to perform the interactive data visualisation using the Plotly library.

The data visualisation application 204 can also include a dashboard module 204f. The dashboard module 204f can cause the video analytics system 100 to create a dashboard on a user interface (UI) using the Dash and Dash Draggable libraries. The four buttons are created using the Dash library while the rest of the dashboard is created using the Dash Draggable library.

The data visualisation application 204 in accordance with embodiments of the present disclosure can address technical problems associated with secure execution of database queries, effective data visualisation, and the creation of a dynamic and interactive dashboard. The data visualisation application 204 in accordance with embodiments of the present disclosure can (i) generate accurate machine-readable data visualisation instructions based on the users' natural language commands, i.e., understand the user's requirements, determine the appropriate data to be extracted and the optimal type of plot for data representation, (ii) generate SQL database queries, i.e., generate machine-readable database query instructions to facilitate the processing and extraction of relevant data from a database, (iii) generate data visualisation, i.e., generate suitable data visualisation to represent the data properly using a corresponding plot library, e.g. Python and Plotly respectively, (iv) generate a dynamic and interactive dashboard, i.e., generate a visual information display where the users can interact with the displayed data and manipulate the dashboard components to their needs, and (v) enhance security measures to prevent malicious attacks, i.e., implement security measures to mitigate malicious attacks such as SQL injection attack on the database and DDOS attack on the application.

Embodiments of the present disclosure also provide an image resolution enhancement application 206, hereinafter interchangeably referred to as a super resolution module. The image resolution enhancement application 206 can cause the video analytics system 100 to increase a resolution of an image beyond its original resolution by using a general adversarial network (GAN). The image resolution enhancement application 206 in accordance with embodiments of the disclosure can include one or more managers, each being a subroutine or program configured to perform one or more specific functions within the application. Each of the one or more managers can include instructions in machine-readable format that are executable by the natural language video analytics system 100 to perform the various functions described in more detail below. In an example embodiment, the image resolution enhancement application 206 can include, but is not limited to, an image loader manager 206a, a scaling manager 206b, a super-resolution manager 206c, a training manager 206d, a drawing manager 206e, a crowd counting manager 206f and a multi-image viewing manager 206g.

In embodiments of the present disclosure, the image loader manager 206a can cause the video analytics system 100 to process one or more images and transmit the one or more images to the output display. In an embodiment, where a plurality of images is processed, the video analytics system 100 can display all images simultaneously, and can be configured to receive one or more user commands for selecting one or more images to be upscaled, adding or removing images, editing file names, rearranging files, viewing file metadata, and previewing images.

In exemplary embodiments, the scaling manager 206b can cause the video analytics system 100 to receive an input from the user, the input associated with a scaling factor for resolution upscaling of the user-selected images. The user can be presented with the default options to perform 2-times or 4-times upscaling. Alternatively, users can provide their own pretrained models with their own defined degree of upscaling. In exemplary embodiments, the super-resolution manager 206c can cause the video analytics system 100 to increase a resolution of the user-selected image beyond its original resolution by using a general adversarial network (GAN). In an exemplary embodiment, a suitable general adversarial network (GAN) can be used. The GAN can include, but is not limited to, Real-ESRGAN (Real-World Enhanced Super-Resolution General Adversarial Network) from the OpenMMLab 2.0 library. The model is based on the PyTorch framework.

In exemplary embodiments, the image resolution enhancement application 206 can include the training manager 206d. The training manager 206d can cause the video analytics system 100 to facilitate training and storing of user-customised super-resolution models for specific datasets. In an embodiment, training dataset from the users can be divided into two folders: an origin folder, containing the images to be upscaled, and a target folder, containing the corresponding upscaled images in identical order and filename as those in the origin folder. The scaling factor for the upscaling process can be specified by the user. Upon initiation of the training process by the video analytics system 100, a progress bar can be displayed to indicate the progress of the training. A line of text can be present below the progress bar to show the quality metrics employed to evaluate the training progress. Quality metrics include, but is not limited to, the peak signal-to-noise ratio (PSNR ratio), which measures the quality of the super-resolution images relative to the original images. The training manager 206d can save and overwrite the model that achieves the best PSNR ratio. An option can be provided to the user to terminate the training process if the quality is deemed unsatisfactory. In such cases, the model can either be saved in its current state or the automatically saved model can be utilised. Upon completion or termination of the training, a text file documenting the training progress can be saved in the same directory as the model.

In exemplary embodiments, the image resolution enhancement application 206 can include the drawing manager 206e. The drawing manager 206e can cause the video analytics system 100 to provide drawing tools for image annotation within the multi-image view manager. Customisations, including the thickness and colour of the drawing tool, can also be provided by the drawing manager 206e. An undo function can facilitate the reversal of previous annotations. Additionally, an option to save images with or without the applied annotations is provided.

In exemplary embodiments, the image resolution enhancement application 206 can include the crowd counting manager 206f. The crowd counting manager 206f can cause the video analytics system 100 to execute a sequence of steps to crowd count on images. The sequence includes (i) using a pre-trained High-Resolution Network (HRNet) to conduct semantic segmentation on the image, such that individuals are segmented from the foreground, and (ii) using Focal Inverse Distance Transformation (FIDT) to achieve crowd localization within the segmentation map, wherein each individual is depicted as a blob. The process also includes (iii) converting the segmentation map into a heatmap, which is then rendered viewable within the multi-image view manager, and (iv) enumerating the number of maximum intensity points within each localized blob to crowd count. The resultant count can be displayed as superimposed text on the heatmap.

In exemplary embodiments, the image resolution enhancement application 206 can include the multi-image viewing manager 206g. The multi-image viewing manager 206g can cause the video analytics system 100 to facilitate creation and viewing of multiple image windows, which can be freely resized and rearranged on the output display. Each image window can include a dropdown list for selecting the image to be displayed. Additionally, each image window can be equipped with its own drawing manager and crowd counting manager. The crowd counting manager can be excluded for generated heatmaps.

In embodiments of the present disclosure, the image resolution enhancement application 206 can advantageously provide an interface that can facilitate a side-by-side close-up comparison between the original and upscaled images and provide tools for comprehensive image analysis and the verification of historical uploads. In example embodiments, the image resolution enhancement application 206 can increase a resolution of an image beyond its original resolution by using a general adversarial network (GAN) with a graphical processing unit (GPU) to perform fast inference.

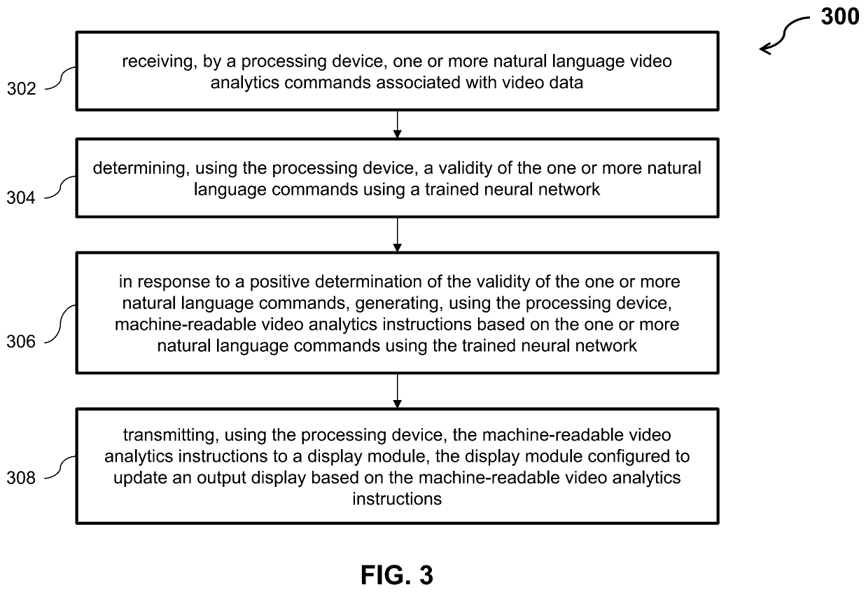

FIG. 3 shows a flowchart illustrating a method 300 of processing one or more natural language video analytics commands, in accordance with embodiments of the disclosure. The method 300 can be implemented by the server 106 of system 100, hereinafter interchangeably referred to as a processing device. The method 300 broadly includes step 302 of receiving, by a processing device, one or more natural language video analytics commands associated with video data, step 304 of determining, using the processing device, a validity of the one or more natural language commands using a trained neural network, in response to a positive determination of the validity of the one or more natural language commands, step 306 of generating, using the processing device, machine-readable video analytics instructions based on the one or more natural language commands using the trained neural network and step 308 of transmitting, using the processing device, the machine-readable video analytics instructions to a display module, the display module configured to update an output display based on the machine-readable video analytics instructions.

Embodiments of the present disclosure also provide a graphical user interface (GUI) application. The GUI application can integrate the three aforementioned video analytics application 202, data visualisation application 204 and image resolution enhancer application 206 to facilitate efficient usage and navigation. The following paragraphs describe each of the video analytics application 202, data visualisation application 204 and image resolution enhancer application 206 in more detail and how the applications can interact with the GUI application. In embodiments, the video analytics application 202 can cause the video analytics system 100 to provide a user-friendly chat assistant that can simplify interactions with a native language interface, where users can key in their queries in natural language which is then processed by the system 100 to reflect the requested changes directly on the video feed shown on the output display. In embodiments, the chat interface can also maintain the entire conversation history and providing responses in text and graphical format. In the backend, the video analytics application 202 can serve as an assistant that ensures the user requests are handled securely and efficiently, using the trained neural network to process the requests and generate the relevant code that will be seamlessly integrated with the GUI application. For example, the video analytics application 202 can cause the video analytics system 100 to screen each user request for safety and practicality and reject the ones that are in violation of safety standards with text feedback sent back to the user via the chat interface. The video analytics application 202 can cause the video analytics system 100 to handle display configuration change requests from users, including but not limited to changes in background configurations, elements visibility toggles, and screen preferences adjustments. The video analytics application 202 can cause the video analytics system 100 to perform real-time analysis such as tracking and analysing people's movement or filtering specific attributes in a crowd. With access to historical video recordings, the video analytics application 202 can cause the video analytics system 100 to retrieve specific video segments that are event-triggered (e.g., people entry or exit, objects left behind, etc.) and provide users the flexibility to play, edit, and save these extracted recordings.

In exemplary embodiments, the video analytics application 202 together with the GUI application can cause the video analytics system 100 to facilitate user navigation, support multiple functionalities such as multi-video view and prompt history log and allow users to personalise on-screen interface such as rearrangement of widgets or panels to display relevant information like live video feeds, prompt generated video compilation, analytics summaries, alerts, recent activities etc. Accordingly, the video analytics application 202 in accordance with embodiments can allow users without technical expertise to easily customise their video analysis and decision-making process.

In exemplary embodiments, the data visualisation application 204 can be a web application. The data visualisation application 204 can cause the video analytics system 100 to perform data visualisation based on text commands from users written in natural language using a trained neural network. The neural network can be trained to generate a SQL query based on the user's text input and the corresponding connected database. The query can be then passed to the database to extract the relevant information in the form of a data frame. The data in the table can be presented in tabular or graphical form depending on suitability and the user's commands. For instance, users can request specific statistics and chart type in their query which will be reflected in the generated graphical component. The data visualisation application 204 can cause the video analytics system 100 to present information in the form of individual graphical components on the output display, and the components can be dynamically resized and reorganised to facilitate analysis. To enable seamless real-time data analysis, the data visualisation application 204 can cause the video analytics system 100 to continuously update to displayed data in real-time, to provide immediate insights and aid decision-making. Furthermore, the data visualisation application 204 can cause the video analytics system 100 to facilitate the “drag and drop” of dynamically generated graph components into the static permanent UI.

In exemplary embodiments, the image resolution enhancer application 206 can cause the video analytics system 100 to enhance an image beyond its original resolution. The image resolution enhancer application 206 can cause the video analytics system 100 to accept multiple image formats as input and receive a user-specified degree of upscaling or magnification (e.g. 2-times, 4-times and 8-times) for the image upscaling process. The image resolution enhancer application 206 can cause the video analytics system 100 generate higher-resolution images and can store the images in various image formats. The image resolution enhancer application 206 has crowd counting functionality. The UI facilitates the user in uploading input images, viewing the super-resolution output, generating a heatmap counterpart, and displaying the resulting people count. The image resolution enhancer application 206 together with the GUI application can cause the video analytics system 100 to perform drawing on top of a heatmap to facilitate image analysis and maintain a scroll bar of the historic uploads that can be displayed on the output display upon double clicking. The image resolution enhancer application 206 can allow users to conveniently perform super-resolution, crowd counting and image analysis on the same interface.

In exemplary embodiments, the GUI application may be implemented as a web interface, which integrates the aforementioned applications and facilitates secure access to these functionalities. The web interface can ensure that the applications are accessible in a unified and secure manner, and can provide a platform for user interaction with the described applications. In embodiments, each user can be associated with a distinct set of credentials, comprising different levels of access control and permissions for the features of each application. For example, a user assigned minimal viewing permissions will be restricted to viewing the live video feed within the video analytics application 202 and the pre-generated real-time data visualisations within the data visualisation application 204. In an example embodiment, the user may not be granted access to the image resolution enhancer application 206, nor will they possess the capability to execute any additional actions within the aforementioned video analytics and data visualisation applications 202, 204.

In an example embodiment, the video analytics application 202 and the GUI application can cause the natural language video analytics system 100 to receive and display video analytics within an interactive dashboard. The functionalities can be provided via a web application. The video analytics application 202 and the GUI application can cause the natural language video analytics system 100 to receive user inputs (e.g. one or more natural language video analytics commands) via a chat interface. The request can be handled by prompt classification manager 202b as described above, which can cause the natural language video analytics system 100 to assess the user input by determining first whether the request is relevant to the software's capabilities, followed by the request's feasibility with respect to the software's current state of functionality, and lastly categorisation of the request into either “Display” or “Recording”. The user can be informed if the input is deemed to be irrelevant or infeasible. An input that is classified as “display” can be handled by the drawing manager 202c, which can cause the video analytics system 100 to handle drawing operations on the video frames using real-time data features like bounding boxes, tracking identity (tracking ID), frames per second (FPS), and region of interests (ROIs). An example of a user input can include, but is not limited to, “change the colour of the bounding box to red”. An input that is classified as “recording” is handled by the recording manager 202d which can cause the video analytics system 100 to retrieve and process the relevant recordings and metadata. An example of a user input can include, but is not limited to, “count the number of people entering the store from 5:30 PM to 6:30 PM on 15th Aug. 2023”. The video analytics application 202 can cause the natural language video analytics system 100 to generate machine-readable video analytics instructions based on the natural language commands using a trained neural network and display information associated with the machine-readable video analytics instructions on an output display. These changes can then be observed in the multi-video window manager on the user interface where side-by-side comparisons between the original video window and the generated video windows can be performed by the user. Automated analytics summaries as overlap text on the generated video windows or as a separate window on the interface can be generated as well. The generated videos can be stored in a widely supported format (i.e., H.264/H.265 MP4, MOV etc.).

In an example embodiment, the data visualisation application 204 and the GUI application can cause the natural language video analytics system 100 to generate data visualisation within an interactive dashboard. The functionalities can be provided via a web application which would require user authentication and verification before access is permitted. The type of user privileges and permissions given to the account will depend on the role given to the user. The data visualisation application 204 and the GUI application can cause the natural language video analytics system 100 to receive a text query (e.g. video analytic instructions) in natural language from a user. The data visualisation application 204 can cause the natural language video analytics system 100 to generate a SQL query using an LLM. In an embodiment, the text query can be passed to the LLM in the form of a prompt which contains database table schema and description to generate the SQL query with renamed column headings to make them more easily understood by users. The generated query can be passed through one or more of a blacklist and whitelist security checks (that is, the filter can be a blacklist, a whitelist or both) to mitigate SQL injection attacks. The screened query can then used to extract relevant results in the form of a table with values and column headings from a PostgreSQL database. The extracted data table with the renamed column headings can be passed to the LLM in the form of a prompt to generate a text response to the text query. The same data table can also be passed to the LLM in the form of a prompt to generate Python code to be used to perform data visualisation using the Python Plotly library. The generated code can be executed and the data visualisation output can be displayed on an user interface dashboard that is created using the Python Dash and Dash Draggable libraries. The output can be a single removable graph component that can be dragged and resized within the dashboard itself. Multiple graph components that can be rearranged freely on the dashboard to perform comparisons can also be generated. Users can save the graph components in the dashboard(s), which it can be edited for one or multiple dashboard(s). In an example embodiment, two buttons can be implemented on the dashboard to allow users to perform the following actions (i) a “Run Query” button to visualize the query as a removable graph component (alternatively, the “Enter” or “Return” key can be pressed to perform the same action, and pressing the button again will generate additional removable graph components on the dashboard) and (ii) a “Clear” button to remove all graph components on the dashboard. All the generated graph components can be rearranged and resized freely inside the dashboard itself, making it a dynamic dashboard. Use of the graphing libraries such as Plotly library for data visualisation can allow for interactive plots where users can mouse over the plot to view additional information.

In an example embodiment, the image resolution enhancement application 206 and the GUI application can cause the natural language video analytics system 100 to increase a resolution of an image beyond its original resolution by using a general adversarial network (GAN). The functionalities can be provided via a web application. The image resolution enhancement application 206 and the GUI application can cause the natural language video analytics system 100 to receive at least one image for resolution enhancement. In an embodiment, an option to upscale the image resolution by 2× or 4× can be presented to the user. The user can have an option to determine the desired output image format for saving the upscaled images. Upon completion of the upscaling process, the natural language video analytics system 100 can display a multi-image window on the output display to facilitate side-by-side comparison between the original and upscaled images, with functionalities provided for zooming in and out of the images. In an example embodiment, a drawing tool can be provided to allow annotations on the images. An option to save these changes is also available. If the “crowd counting” request is received, the natural language video analytics system 100 can generate an additional heatmap image along with the corresponding people count, presented as overlapping text within the multi-image window. The user can have the option to save either the heatmap image, the upscaled images, or both. The user interface can include a scrollable section that displays all historical uploads, aiding in the identification of duplicate images. In exemplary embodiments, the natural language video analytics system 100 can train and save custom super-resolution models using custom image datasets. The UI design can facilitate super-resolution upscaling and side-by-side comparisons.

In an example embodiment, the GUI application can integrate the three aforementioned video analytics application 202, data visualisation application 204 and image resolution enhancer application 206 to facilitate efficient usage and navigation, and enable various operations to be performed efficiently.

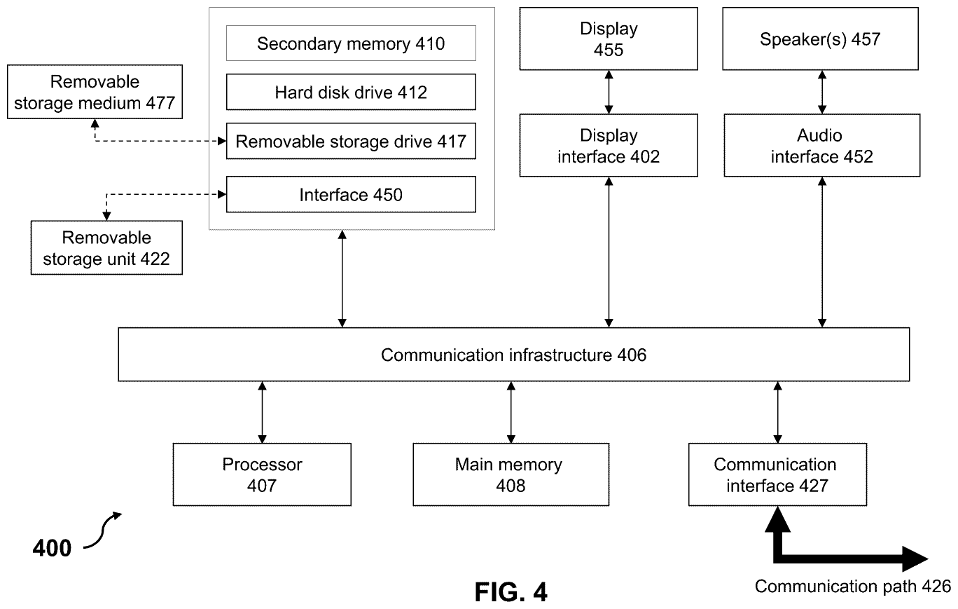

FIG. 4 depicts an exemplary computing device 400, hereinafter interchangeably referred to as a computer system 400, where one or more such computing devices 400 may be used to execute the method 300 of FIG. 3. One or more components of the exemplary computing device 400 can also be used to implement the system 100. The following description of the computing device 400 is provided by way of example only and is not intended to be limiting.

As shown in FIG. 4, the example computing device 400 includes a processor 407 for executing software routines. Although a single processor is shown for the sake of clarity, the computing device 400 may also include a multi-processor system. The processor 407 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 417, which may include a magnetic tape drive, an optical disk drive, a solid state storage drive (such as a USB flash drive, a flash memory device, a solid state drive or a memory card), or the like. The removable storage drive 417 reads from and/or writes to a removable storage medium 477 in a well-known manner. The removable storage medium 477 may include magnetic tape, optical disk, non-volatile memory storage medium, or the like, which is read by and written to by removable storage drive 417. As will be appreciated by persons skilled in the relevant art(s), the removable storage medium 477 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 450 which allow software and data to be transferred from the removable storage unit 422 to the computer system 400.

The computing device 400 also includes at least one communication interface 427. The communication interface 427 allows software and data to be transferred between computing device 400 and external devices via a communication path 426. In various embodiments of the inventions, the communication interface 427 permits data to be transferred between the computing device 400 and a data communication network, such as a public data or private data communication network. The communication interface 427 may be used to exchange data between different computing devices 400 which such computing devices 400 form part an interconnected computer network. Examples of a communication interface 427 can include a modem, a network interface (such as an Ethernet card), a communication port (such as a serial, parallel, printer, GPIB, IEEE 1394, RJ45, USB), an antenna with associated circuitry and the like. The communication interface 427 may be wired or may be wireless. Software and data transferred via the communication interface 427 are in the form of signals which can be electronic, electromagnetic, optical or other signals capable of being received by communication interface 427. These signals are provided to the communication interface via the communication path 426.

As shown in FIG. 4, the computing device 400 further includes a display interface 402 which performs operations for rendering images to an associated display 450 and an audio interface 452 for performing operations for playing audio content via associated speaker(s) 457.

As used herein, the term “computer program product” may refer, in part, to removable storage medium 477, removable storage unit 422, a hard disk installed in storage drive 412, or a carrier wave carrying software over communication path 426 (wireless link or cable) to communication interface 427. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 427. Such computer programs, when executed, enable the computing device 400 to perform one or more features of embodiments discussed herein. In various embodiments, the computer programs, when executed, enable the processor 407 to perform features of the above-described embodiments. Accordingly, such computer programs represent controllers of the computer system 400.

Software may be stored in a computer program product and loaded into the computing device 400 using the removable storage drive 417, the storage drive 412, or the interface 450. The computer program product may be a non-transitory computer readable medium. Alternatively, the computer program product may be downloaded to the computer system 400 over the communication path 426. The software, when executed by the processor 407, causes the computing device 400 to perform the necessary operations to execute the method 300 as shown in FIG. 3.

It is to be understood that the embodiment of FIG. 4 is presented merely by way of example to explain the operation and structure of the system 400. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the various functions and operations of the system as described in the above embodiments.

When the computing device 400 is configured to realise the system 100 to process one or more natural language video analytics commands, the system 100 will have a non-transitory computer readable medium having stored thereon an application which when executed causes the system 100 to perform steps comprising: (i) receiving, by a processing device, one or more natural language video analytics commands associated with video data, (ii) determining, using the processing device, a validity of the one or more natural language commands using a trained neural network, in response to a positive determination of the validity of the one or more natural language commands, (iii) generating, using the processing device, machine-readable video analytics instructions based on the one or more natural language commands using the trained neural network and (iv) transmitting, using the processing device, the machine-readable video analytics instructions to a display module, the display module configured to update an output display based on the machine-readable video analytics instructions.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A natural language video analytics system, the system comprising:
at least one processor; and
at least one memory including computer program code;
wherein the at least one processor, at least one memory and the computer program code are configured to allow the system to:
receive one or more natural language video analytics commands associated with video data;
determine a validity of the one or more natural language commands using a trained neural network;
in response to a positive determination of the validity of the one or more natural language commands,
generate machine-readable video analytics instructions based on the one or more natural language commands using the trained neural network; and
transmit the machine-readable video analytics instructions to a display module, the display module configured to update an output display based on the machine-readable video analytics instructions.

2. The system as claimed in claim 1, wherein to determine the validity of the one or more natural language commands, the system is configured to:
determine a relevance of the one or more natural language video analytics commands to analytics of the video data using the trained neural network; and
optionally, determine if the one or more natural language video analytics commands fall within a processing capability of the natural language video analytics system using the trained neural network.

3. The system as claimed in claim 1, wherein the machine-readable video analytics instructions comprise video overlay instructions, and wherein the system is configured to:
receive the video data and the video overlay instructions;
modify the video data based on the video overlay instructions; and
transmit the video data modified based on the video overlay instructions to the output display.

4. The system as claimed in claim 1, wherein the machine-readable video analytics instructions comprise video transformation instructions, and wherein the system is configured to:
receive the video data and the video transformation instructions;
modify the video data based on the video transformation instructions; and
transmit the video data modified based on the video transformation instructions to the output display.

5. The system as claimed in claim 1, wherein the system is further configured to:
compare the machine-readable video analytics instructions against an access control list;
in response to a result of the comparison indicative of authorised access,
retrieve video-derived data from one or more databases associated with the set of video data, based on the machine-readable video analytics instructions;
generate one or more data representations using the retrieved data and the machine-readable video analytics instructions, and
transmit the one or more data representations to the display module.

6. The system as claimed in claim 5, wherein the system is further configured to:
generate a text response based on the retrieved data and the machine-readable video analytics instructions; and
transmit the text response to the display module.

7. The system as claimed in claim 5, wherein the system is further configured to:
generate the video-derived data based on a pre-determined set of video analytics instructions using the video data and a trained video analytics algorithm; and
store the video-derived data and the video data in the one or more databases.

8. A method of processing one or more natural language video analytics commands, the method comprising:
receiving, by a processing device, one or more natural language video analytics commands associated with video data;
determining, using the processing device, a validity of the one or more natural language commands using a trained neural network;
in response to a positive determination of the validity of the one or more natural language commands,
generating, using the processing device, machine-readable video analytics instructions based on the one or more natural language commands using the trained neural network; and
transmitting, using the processing device, the machine-readable video analytics instructions to a display module, the display module configured to update an output display based on the machine-readable video analytics instructions.

9. The method as claimed in claim 8, wherein the step of determining the validity of the one or more natural language commands using the trained neural network comprises one or more of the steps of:
determining, using the processing device, a relevance of the one or more natural language video analytics commands to analytics of the video data using the trained neural network; and
determining, using the processing device, if the one or more natural language video analytics commands fall within a processing capability of natural language video analytics system using the trained neural network.

10. The method as claimed in claim 8, wherein the machine-readable video analytics instructions comprise video overlay instructions, and wherein the method further comprises:
receiving, by the display module, the video data and the video overlay instructions,
modifying, using the display module, the video data based on the video overlay instructions; and
transmitting, using the display module, the video data modified based on the video overlay instructions to the output display.

11. The method as claimed in claim 8, wherein the machine-readable video analytics instructions comprise video transformation instructions, and wherein the method further comprises:
receiving, by the display module, the video data and the video transformation instructions,
modifying, using the display module, the video data based on the video transformation instructions; and
transmitting, using the display module, the video data modified based on the video transformation instructions to the output display.

12. The method as claimed in claim 8, further comprising the steps of:
comparing, using the processing device, the machine-readable video analytics instructions against an access control list;
in response to a result of the comparison indicative of authorised access,
retrieving, using the processing device, video-derived data from one or more databases associated with the video data, based on the machine-readable video analytics instructions;
generating, using the processing device, one or more data representations using the retrieved data and the machine-readable video analytics instructions, and
transmitting, using the processing device, the one or more data representations to the display module, the display module configured to update the output display based on the one or more data representations.

13. The method as claimed in claim 12, further comprising the steps of:
generating, using the processing device, a text response based on the retrieved data and the machine-readable video analytics instructions; and
transmitting, using the processing device, the text response to the display module.

14. The method as claimed in claim 12, further comprising the steps of:
generating, using the processing device, the video-derived data based on a pre-determined set of video analytics instructions using the video data and a trained video analytics algorithm; and
storing the video-derived data and the video data in the one or more databases.
